(19) United States
(12) Patent Application Publication
(10) Pub. No.: US 2025/0113942 A1
(43) Pub. Date: Apr. 10, 2025

(54) AIR FRYER

(71) Applicant: Tsann Kuen (Zhangzhou) Enterprise Co., Ltd., Zhangzhou City (CN)

(72) Inventors: Yixin ZHAN, Zhangzhou City (CN); Bo WEI, Zhangzhou City (CN)

(21) Appl. No.: 18/639,163

(22) Filed: Apr. 18, 2024

(30) Foreign Application Priority Data
Oct. 10, 2023 (CN) 202322717152.0

(51) Int. Cl. A47J 37/06

(52) U.S. Cl. CPC A47J 37/0641

(57) ABSTRACT

This application discloses an air fryer, including a housing. A hot air component and a cooking chamber are arranged in the housing. A fryer body is arranged in the cooking chamber, and a baking pan is arranged in the fryer body. The baking pan includes a baking pan body and a deflector extending away from a center of the baking pan along an edge of the baking pan body. When the air fryer is used to cook food, hot air generated by the hot air component can be deflected into a bottom of the baking pan by the deflector on the baking pan, so that a temperature at a top and a bottom of the baking pan is uniform. Thus, upper and lower sides of the food are heated uniformly, and a user does not need to turn over the food on the baking pan during cooking.

### CROSS-REFERENCE TO RELATED APPLICATIONS

This application claims priority to Chinese Patent Application 202322717152.0, filed on Oct. 10, 2023, which is incorporated herein by reference.

### TECHNICAL FIELD

This application relates to a food cooking device, and in particular to an air fryer.

### BACKGROUND

When the existing air fryer cooks food, the food is usually placed on a baking pan in the fryer body, and hot air from a hot air component is utilized to cook the food on the baking pan. However, since most of the hot air flows through the top of the baking pan and cannot enter the bottom of the baking pan to cook the bottom of the food, the user needs to manually turn over the food during cooking such that both sides of the food can be heated by the hot air.

The structure of this air fryer requires the user to turn over the food regularly during cooking, and it is not easy for the user to turn over the food at proper time, which is inconvenient for the user and may not cook the food effectively.

### SUMMARY

An objective of this application is to provide an air fryer that can alleviate at least one defect in the prior art.

This application provides an air fryer, including a housing. A hot air component and a cooking chamber are arranged in the housing. A fryer body is arranged in the cooking chamber, and a baking pan is arranged in the fryer body. The baking pan includes a baking pan body and a deflector extending away from a center of the baking pan along an edge of the baking pan body.

According to the air fryer of this application, the baking pan includes a fence that is arranged along the edge of the baking pan body and is higher than the baking pan body, and the deflector extends outwards away from the center of the baking pan along an upper end of the fence.

According to the air fryer of this application, the deflector includes a deflection surface, and the deflection surface is inclined towards the center of the baking pan with respect to a plane where the baking pan is located.

According to the air fryer of this application, an inclination angle of the deflection surface with respect to the plane where the baking pan is located ranges from 110 degrees to 150 degrees.

According to the air fryer of this application, a bottom of the baking pan has support members, and the support members support the baking pan in the cooking chamber such that the baking pan has a certain distance from a bottom of the cooking chamber.

According to the air fryer of this application, the baking pan body includes ribs that are distributed uniformly and protrude upwards, and oil drain holes running up and down through the baking pan body, and the oil drain holes and the ribs are arranged at intervals.

According to the air fryer of this application, the baking pan body includes one or a plurality of ventilation holes running up and down.

According to the air fryer of this application, the baking pan includes an air duct retaining wall in a shape of a hollow column. The air duct retaining wall is detachably connected to an upper side of the ventilation hole, the hollow column of the air duct retaining wall corresponds to the ventilation hole in position to form a ventilation duct, and an upper end of the air duct retaining wall is higher than an upper surface of the baking pan.

According to the air fryer of this application, a side wall of the hollow column of the air duct retaining wall is provided with a plurality of wall holes.

According to the air fryer of this application, the air duct retaining wall further includes a base, and a shape of a bottom of the base is matched with a shape of the upper surface of the baking pan body such that the base is steadily connected to the baking pan.

This application has the following beneficial effects: when the air fryer of this structure cooks food, hot air generated by the hot air component can be deflected into the bottom of the baking pan by the deflector on the baking pan, so that the temperature at the top and the bottom of the baking pan is uniform. Thus, upper and lower sides of the food are heated uniformly, and the user does not need to turn over the food on the baking pan during cooking.

### BRIEF DESCRIPTION OF DRAWINGS

Other features and effects of this application will be apparent from the implementations of the drawings:

FIG. 1 is a three-dimensional view illustrating a structure of an air fryer;

FIG. 2 is a sectional view illustrating the structure of the air fryer;

FIG. 3 is a sectional view illustrating the structure of a fryer body including a baking pan;

FIG. 4 is a three-dimensional view illustrating the structure of the baking pan;

FIG. 5 is a three-dimensional view illustrating the structure of the baking pan;

FIG. 6 is a sectional view illustrating the structure of the baking pan taken alone line A-A in FIG. 5;

FIG. 7 is a three-dimensional view illustrating the structure of the baking pan;

FIG. 8 is a three-dimensional view illustrating a base of an air duct retaining wall; and

FIG. 9 is a three-dimensional view illustrating the air duct retaining wall.

### DESCRIPTION OF EMBODIMENTS

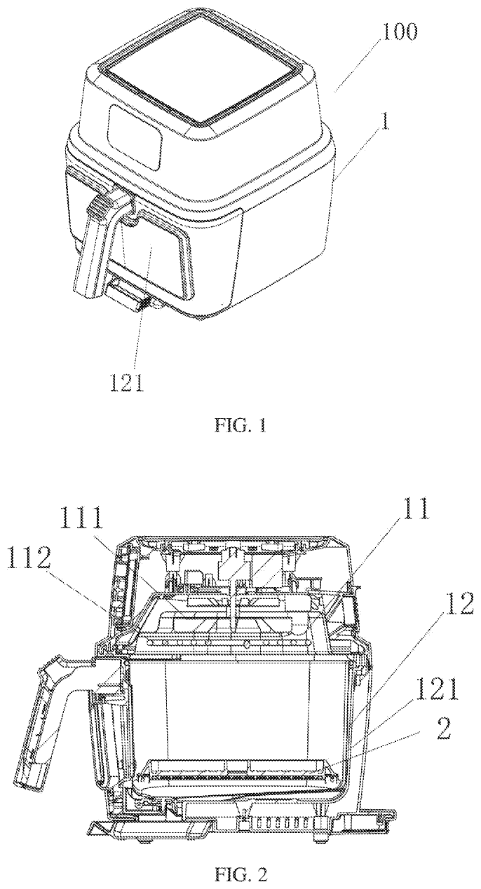

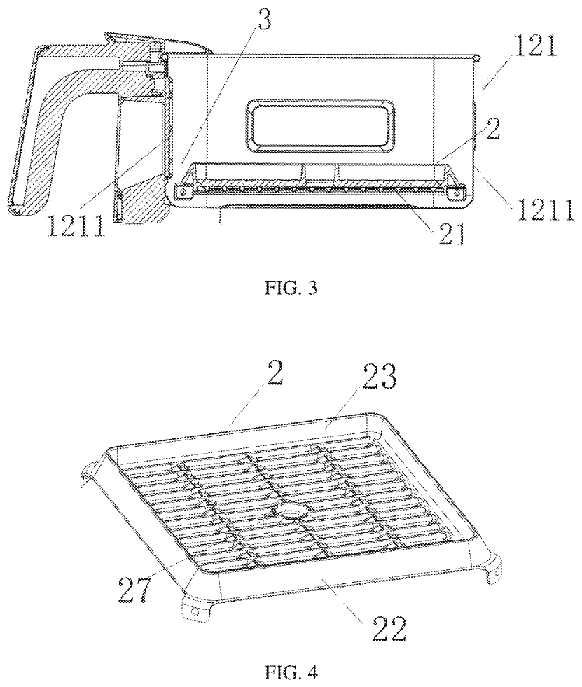

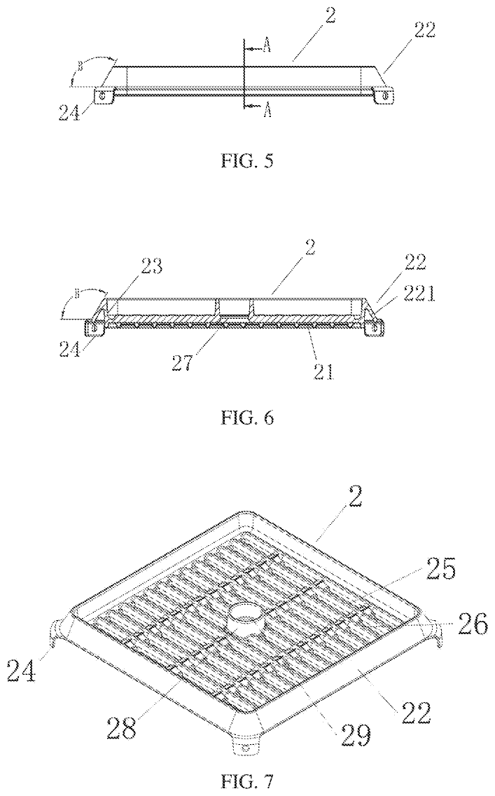

This application will be further described with reference to the following examples, but it should be understood that the examples are for illustrative purposes only and should not be construed as a limitation on the implementation of this application, and that similar components are denoted by the same number. Referring to FIG. 1 to FIG. 8, this application provides an air fryer 100, including a housing 1. A hot air component 11 and a cooking chamber 12 are arranged in the housing 1. The hot air component 11 includes a fan 111 and a heating element 112. The cooking chamber 12 includes a fryer body 121 for cooking food. A baking pan 2 is arranged in the fryer body 121. The baking pan 2 includes a baking pan body 21 and a deflector 22 extending away from a center of the baking pan 2 along an edge of the baking pan body 21.

Before use, the baking pan 2 is put into the fryer body 121, and food is put on the baking pan 2. The fryer body 121 is mounted into the cooking chamber 12. The hot air component 11 is started, and the rotating fan 111 drives air to form hot air flowing through the heating element 112. Under the action of the fan 111, one part of the hot air flows through the surface of the food on the baking pan 2, and the other part of the hot air enters the bottom of the baking pan 2 due to the deflector 22. The deflector 22 arranged on the edge of the baking pan body 21 functions to deflect the hot air, so that the upper and lower sides of the baking pan 2 can be heated by the hot air, and both sides of the food can be cooked without turning over the food.

Specifically, in this example, the baking pan 2 includes a fence 23 that is arranged along the edge of the baking pan body 21 and is higher than the baking pan body 21, and the deflector 22 extends outwards away from the center of the baking pan 2 along an upper end of the fence 23. The fence 23 arranged on the edge of the baking pan body 21 can prevent the food on the baking pan 2 from falling, and make the deflector 22 higher than the baking pan body 21 and closer to the hot air component 11, thereby producing a better deflection effect.

Specifically, the deflector 22 has a deflection surface 221, and the deflection surface 221 is inclined with respect to a plane where the baking pan 2 is located, and inclined towards the center of the baking pan 2 with respect to the plane where the baking pan 2 is located. The deflection surface 221 and a fryer body side wall 1211 form an air inlet 3 with a large top and a small bottom. When the centrifugal hot air generated by the hot air component 11 flows to the baking pan 2 along the fryer body side wall 1211, one part of the hot air flows through the food on the top of the baking pan due to the blocking effect of the upper surface of the baking pan 2, and the other part of the hot air flows into the bottom of the baking pan 2 via the air inlet 3 after reaching the top of the deflector 22. Since the air inlet 3 has a large top and a small bottom, the hot air can quickly reach the bottom of the baking pan 2 through the air inlet 3, so that the bottom of the food on the baking pan 2 can be heated.

As a preferred solution, in this example, the deflection surface 221 is inclined towards the center of the baking pan 2 with respect to the plane where the baking pan 2 is located, and an inclination angle B of the deflection surface 221 with respect to the plane where the baking pan 2 is located ranges from 110 degrees to 150 degrees.

In this example, a bottom of the baking pan 2 is provided with support members 24, the baking pan 2 is placed into the fryer body 121, and the bottom of the baking pan 2 has a certain distance from a bottom of the fryer body 121. When the hot air enters the bottom of the baking pan 2 through the air inlet 3, the bottom of the baking pan 2 has a certain space that allows the hot air to flow through and to sufficiently heat the bottom of the food.

As a preferred solution, in this example, the support members 24 are distributed on a bottom of the deflector 22. Preferably, there are four support members 24 that are distributed uniformly on the bottom of the deflector 22. The support members 24 may also be arranged at other positions on the bottom of the baking pan 2. The support members 24 may also be detached from the baking pan 2; and the support members 24 may be mounted to the bottom of the baking pan 2 before use. Those skilled in the art may design the support members 24 according to needs.

The baking pan body 21 includes ribs 25 that are distributed uniformly and protrude upwards, and oil drain holes 26 running up and down through the baking pan body 21, and the oil drain holes 26 and the ribs 25 are arranged at intervals. The structure of the baking pan 2 is well known to those skilled in the art, and thus will not be described in detail.

Referring to FIG. 4 to FIG. 7, in a preferred example, the baking pan body 21 includes one or a plurality of ventilation holes 27 running up and down. When there is one ventilation hole 27, the ventilation hole 27 is preferably arranged in the middle of the baking pan body 21. When there is a plurality of ventilation holes 27, the ventilation holes may be uniformly arranged on the baking pan body 21.

Before use, the baking pan 2 with the ventilation hole 27 is put into the fryer body 121, and food is put on the baking pan 2. The fryer body 121 is mounted into the cooking chamber. Under the action of the fan, one part of the hot air flows through the surface of the food on the top of the baking pan 2, and the other part of the hot air enters the bottom of the baking pan 2 due to the deflector 22. The hot air entering the bottom of the baking pan 2 may flow out to the upper surface of the baking pan 2 through the ventilation hole 27, so that the hot air can circulate effectively in the fryer body 121. The hot air in the space on the top and the bottom of the baking pan 2 is always in a circulating state, so that the temperature is more stable and more uniform, and the food can be cooked more effectively without turning over the food.

As a preferred solution, in this example, the baking pan 2 further includes an air duct retaining wall 28. The air duct retaining wall 28 is a hollow column, and is detachably connected to an upper side of the ventilation hole 27. The shape of a cross-section of the hollow column of the air duct retaining wall 28 is close to the shape of the ventilation hole 27. When the air duct retaining wall 28 is connected and arranged to an upper side of the ventilation hole 27, the hollow column of the air duct retaining wall 28 corresponds to the ventilation hole 27 in position so as to form a ventilation duct 29 running up and down, and an upper end of the air duct retaining wall 28 is higher than the upper surface of the baking pan 2. When there is a large quantity of food to be cooked or the food to be cooked is too thick, the air duct retaining wall 28 may be placed at the ventilation hole 27 of the baking pan body, and the hot air can be guided by the ventilation duct 29 when circulating from the bottom of the baking pan 2 to the top of the baking pan 2, so that the hot air can flow to above the thick food more easily.

Referring to FIG. 7 to FIG. 8, the air duct retaining wall 28 further includes a base 281, and a shape of a bottom of the base 281 is matched with a shape of the upper surface of the baking pan 2 such that the base 281 is steadily connected to the baking pan 2. Specifically, the base 281 includes recessed portions 2811. The recessed portions 2811 are matched with the protruding upper surface of the rib 25 such that the base 281 can be steadily arranged on the baking pan 2. Those skilled in the art may design the shape of the base 281 according to specific needs.

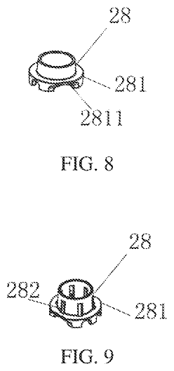

Referring to FIG. 9, a side wall of the hollow column of the air duct retaining wall 28 is provided with a plurality of wall holes 282. When the air duct retaining wall 28 is arranged on the upper side of the ventilation hole 27 and forms the ventilation duct 29, the hot air can flow out to the side surface of the food on the baking pan 2 through the wall holes 282 during the circulation process, so that the food can be heated from all directions.

Based on the above, when the baking pan 2 with the deflector 22 is used to cook food in the air fryer, the circulating hot air can be diverted to the top of the baking pan 2 and the bottom of the baking pan 2 more effectively, so that both sides of the baking pan 2 can be heated and the temperature at the top and the bottom of the baking pan 2 is uniform. Thus, the upper and lower sides of the food are heated uniformly, and the user does not need to turn over the food on the baking pan 2 during cooking while the food can be cooked more effectively.

The above is merely the examples of this application, and cannot be used to limit 5 the scope of implementation of this application. All simple equivalent changes and modifications made according to the claims of this application and the contents of the specification shall fall within the scope of this application.

1. An air fryer, comprising a housing, a hot air component and a cooking chamber being arranged in the housing, a fryer body being arranged in the cooking chamber, and a baking pan being arranged in the fryer body, wherein the baking pan comprises a baking pan body and a deflector extending away from a center of the baking pan along an edge of the baking pan body.

2. The air fryer according to claim 1, wherein the baking pan comprises a fence that is arranged along the edge of the baking pan body and is higher than the baking pan body, and the deflector extends outwards away from the center of the baking pan along an upper end of the fence.

3. The air fryer according to claim 1, wherein the deflector comprises a deflection surface, and the deflection surface is inclined towards the center of the baking pan with respect to a plane where the baking pan is located.

4. The air fryer according to claim 3, wherein an inclination angle of the deflection surface with respect to the plane where the baking pan is located ranges from 110 degrees to 150 degrees.

5. The air fryer according to claim 3, wherein a bottom of the baking pan has support members, and the support members support the baking pan in the cooking chamber such that the baking pan is spaced apart from a bottom of the cooking chamber.

6. The air fryer according to claim 2, wherein the deflector comprises a deflection surface, and the deflection surface is inclined towards the center of the baking pan with respect to a plane where the baking pan is located.

7. The air fryer according to claim 6, wherein an inclination angle of the deflection surface with respect to the plane where the baking pan is located ranges from 110 degrees to 150 degrees.

8. The air fryer according to claim 6, wherein a bottom of the baking pan has support members, and the support members support the baking pan in the cooking chamber such that the baking pan is spaced apart from a bottom of the cooking chamber.

9. The air fryer according to claim 1, wherein the baking pan body comprises ribs that are distributed uniformly and protrude upwards and oil drain holes extending vertically through the baking pan body, and the oil drain holes and the ribs are arranged at intervals.

10. The air fryer according to claim 1, wherein the baking pan body comprises one or a plurality of ventilation holes extending vertically.

11. The air fryer according to claim 10, wherein the baking pan comprises an air duct retaining wall in a shape of a hollow column, the air duct retaining wall being detachably connected to an upper side of the one ventilation hole or one of the plurality of ventilation holes, the hollow column of the air duct retaining wall corresponding to the one or the plurality of ventilation holes in position to form a ventilation duct, and an upper end of the air duct retaining wall being higher than an upper surface of the baking pan.

12. The air fryer according to claim 11, wherein a side wall of the hollow column of the air duct retaining wall is provided with a plurality of wall holes.

13. The air fryer according to claim 11, wherein the air duct retaining wall further comprises a base, and a shape of a bottom of the base is matched with a shape of an upper surface of the baking pan body such that the base is steadily connected to the baking pan.
